(19) United States
(12) Patent Application Publication
(10) Pub. No.: US 2007/0109793 A1
(43) Pub. Date: May 17, 2007

(54) Lamp shade furnished with similar stained glass

(76) Inventor: Hsi-Chun Lin, Taipei (TW)

Correspondence Address: TROXELL LAW OFFICE PLLC, Suite 1404, 5205 Leesburg Pike, Falls Church, VA, 22041, US

(21) Appl. No.: 11/274,136

(22) Filed: Nov. 16, 2005

(51) Int. Cl. F21V 11/00

(52) U.S. Cl. 362/356

(57) ABSTRACT

A lamp shade furnished with similar stained glasses, which comprises a metal frame furnished with a plurality of hollow panes to be grouted with color melted acrylic liquid by means of a grouting apparatus; as soon the melted acrylic liquid is cooled, a lamp shade furnished with a similar stained glass is done.

### BACKGROUND OF THE INVENTION

1. Field of the Invention

This invention relates to a lamp shade, and particularly to a lamp shade furnished with similar stained glass.

2. Description of the Prior Art

To say a conventional embedded glass is to say that a decorative frame is made of a plurality of metal wires to form into various patterns, such as a geometric design, or scenery sights, or animals and birds, ect. In one decorative frame, there is a plurality of hollow panes, of which each is mounted or embedded with a color glass or a man-made special small glass pane; then, the glass pane is fastened in place with a tin bead soldered between the glass edge and the frame till all the glass panes being mounted into the frame as designed.

In a recent conventional glass-embedding work, a bright metal strip is formed into a groove within a frame designed; then, the metal strip is bent into a form as designed by means of a bending machine; all the metal strips are assembled into a beautiful pattern; then, a plurality of special glass panes is mounted in the small frames respectively; each special glass is embeded in a pane with a suitable pressure; if necessary, the special glasses may fastened in place with a seal material.

Inside a frame designed, a figurative frame may be formed, and the figurative frame includes a plurality of hollow panes, of which each is embedded with a special small glass pane made with delicate process; such a frame has been used widely in a door, window, screen and in a lamp shade, etc.

The conventional lamp shade embedded with decorative glass is usually made with the aforesaid method.

In another conventional lamp shade embedded with decorative glass, such as U.S. Pat. No. 4,557,772, it is a process for making stained glass Tiffany-type lamp shades which comprises providing a kit containing an inscribed fiberglass form, a pressure-sensitive wax adhesive for attaching shaped pieces of different sized circumscribed areas on the surface of the form, and a print on which a particular design is imprinted corresponding to the circumscribed areas on the form, and which may be cut out into patterns to be used to cut stained glass of different colors into pieces to conform to the various shapes and sizes to be incorporated into the design, A transparency is also provided on which the entire design is reproduced to slightly expanded size as opaure lines on a transparent medium. The transparency is placed over a light box, and each cut stained glass piece is placed in its corresponding position on the transparency as a preview to aid in the color selection of the stained glass pieces.

### SUMMARY OF THE INVENTION

The prime object of the present invention is to provide a lamp shade furnished with similar stained glasses, in which a melted acrylic liquid is grouted into every hollow pane of a lamp shade with a lining form underneath; as soon as the acrylic liquid is cooled, the lamp shade will become a shade decortated with artistic stained glasses.

Another object of the present is to provide a lamp shade furnished with similar stained glasses, in which the figurative lamp shade has a figurative frame surface made of a plurality of metal wires to form into a decorative frame, i.e., a plurality of hollow pane surfaces; then, a melted acrylic liquid is grouted into every hollow pane; after the acrylic liquid is cooled, a lamp shade furnished with similar stained glasses is done.

Still another object of the present invention is to provide a lamp shade furnished with similar stained glasses, in whidh the decorative frame includes a plurality of hollow panes made of metal wires; every hollow pane is to be grouted with a melted acrylic liquid in accordance with the pattern and colors of the decorative frame designed so as to have the lamp shade provided with a figrative decoration similar to a stained glass.

A further object of the present invention is to provide a lamp shade furnished with similar stained glasses, in which the decorative frame made of metal wires to form into hollow panes is mounted with a separable lining form underneath; after the melted acrylic liquid grouted therein is cooled, the lining form is removed; then, a smooth inner surface in the lamp shade will be done.

A still further object of the present invention is to provide a lamp shade furnished with similar stained glasses, in which the melted acrylic liquid grouted into the hollow panes of the decorative frame will adhere to the metal wires immediately upon grouting work; as soon as the scrylic liquid is cooled, the decorative panes and the metal wires will be fastened together without separation.

Yet another object of the present invention is provide a lamp shade furnished with similar stained glasses, in which the melted acrylic liquid is to be grouted on the hollow panes of the lamp shade mounted with a lining form, and such lamp shade may be used in desk lamp, floor lamp, table lamp, ceiling lamp and wall lamp, ect. As soon as the light rays cast through the lamp shade, a brilliant color visual effect will be shown.

### BRIEF DESCRIPTION OF THE DRAWINGS

FIG. 1 is a plan view of the table lamp of the present invention, showing the fixture structure of the lamp shade made of metal wire.

FIG. 2 is plan view of the table lamp of the present invention, showing the support stem and the stand base thereof.

FIG. 3 is a perspective view of the present invention, showing the lamp shade frame and the lining form being disassembled.

FIG. 4 is a perspective view of the present invention, showing the assembled view of the lamp shade frame and the lining form.

FIG. 5 is a view showing the grouting operation according to the present invention.

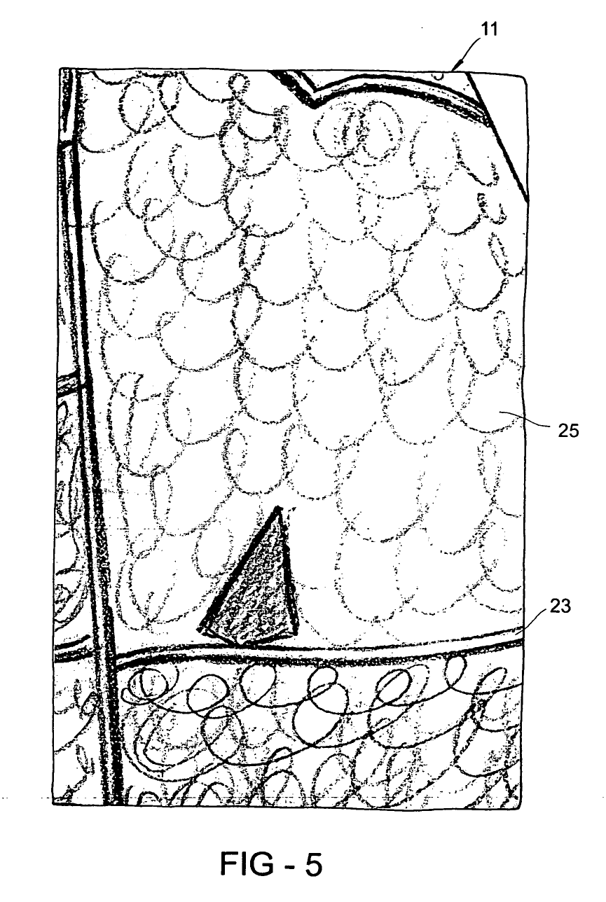

FIG. 6 is a plan view of a stable lamp of the present invention, showing the lamp shade frame made of a thin plate.

FIG. 7 is a photo view of the present invention.

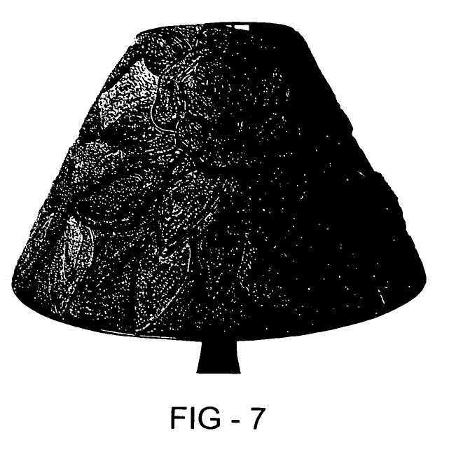

### DETAILED DESCRIPTION OF THE PREFERRED EMBODIMENT

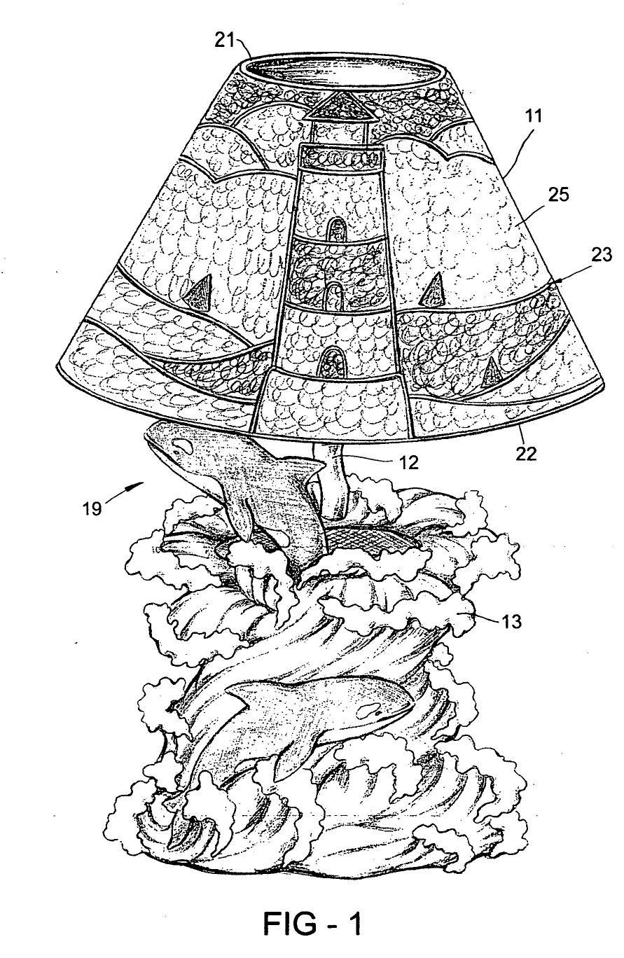

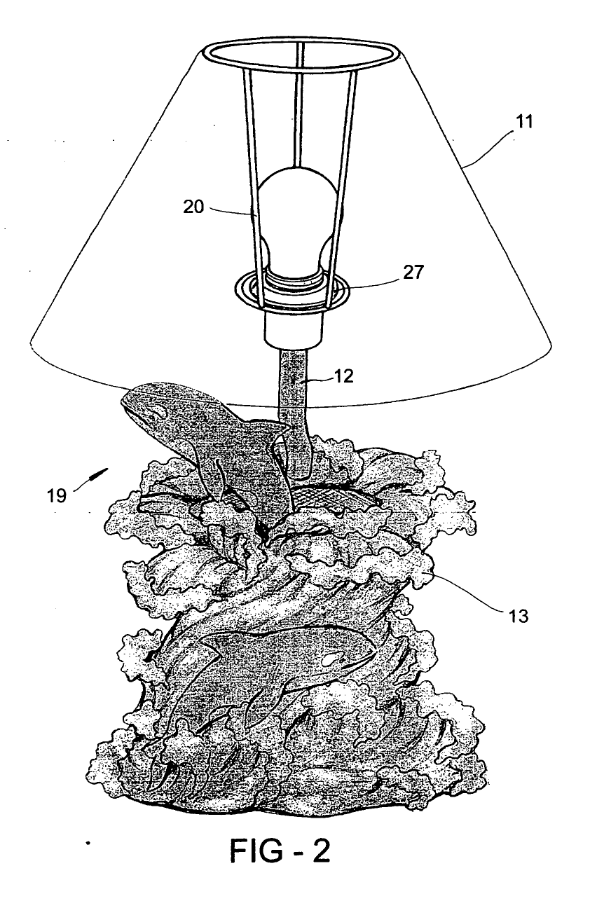

This invention relates to a lamp shade furnished with similar stained; as shown in FIGS. 1 and 2, the lamp is substantially an art table lamp 19, of which the upper part of the stand base 13 has a support stem 12 mounted with a bulb socket, a fixture structure 26 and a support frame 20. The upper part of the support frame 20 is mounted with a lamp shade 11; the pattern of the lamp shade 11 is designed to be mounted with a plurality of glass panes embedded in place.

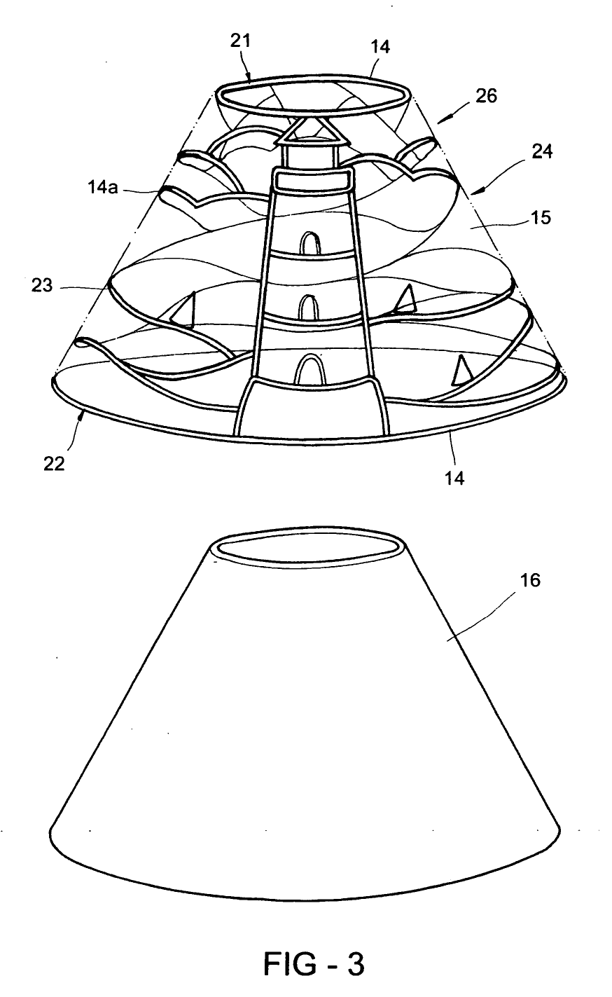

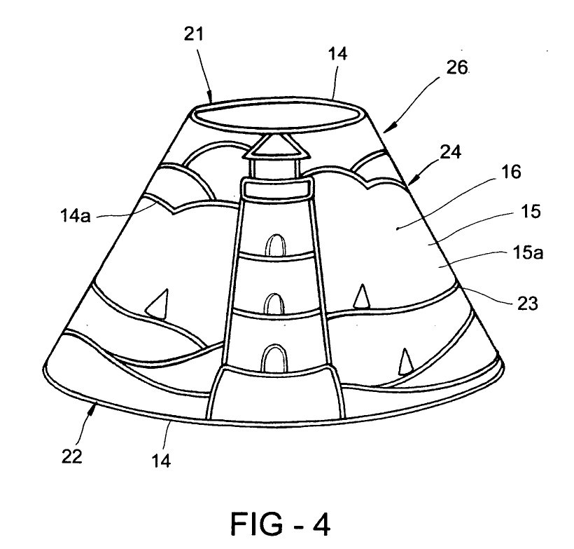

Referring to FIGS. 1 to 4, the lamp shade 11 mounted to the support frame 20 is made of a plurality of glass panes embedded in place. The first step of making the lamp shade 11 is to make a fixture structure 26, which includes an upper frame 21, a lower frame 22 and a middle frame 23. The upper frame 21 and the lower frame 22 are made of a metal wire 14 to be bent into hoops with different suitable diameters respectively according to the lamp shape as designed; the middle frame 23 mounted between the upper frame 21 and the lower frame 22 is bent into a form according to the pattern as designed with a plurality of pieces of wire having different length; the connection point between two pieces of wire can be soldered up so as to have the middle frame 23 formed into a decorative frame 24 as desired.

After a decorative frame 24 of the lamp shade frame 26 is done, a lining form 16 is mounted therein so as to provide an inner flat surface. To make a stained glass lamp shade, use a grouting apparatus 17 to have an acrylic liquid poured into every separate grouting pane 15; during grouting operation, the diameter and the speed of the grouting can be controlled properly so as to have the density of the acrylic liquid changed; then, after the acrylic liquid is cooled down, each figurative pane surface 25 will have a different color; when no light goes through the pane surface, the pattern and color thereof can be used as an ornament; as soon as the inner light goes through the pane surface, another ornament effect will be shown by means of light refraction and the figurative pane surface 25; therefore, the pattern of the lamp shade 11 would show a visual effect similar to that of the conventional glass panes embedded in place.

The process for making the lamp shade with similar stained glass is as follows:

1. To make a lamp shade frame 26, the lamp shade frame 26 should be formed into a shape in accordance with the form of a lamp designed. As shown in the figures mentioned, the lamp shade frame 26 is a cone-shaped shade made of metal wires. The lamp shade frame 26 includes an upper frame 21, a lower frame 22 and a middle frame 23. The decorative frame 24 is formed according to the lamp shade form; the decorative frame 24 is made of a plurality of metal wires 14abent into a curve respectively; every contact point of two wires is soldered together; every separate grouting pane 15 is formed with metal wires 14a, and every grouting pane has a different form. The metal wires 14a and thin plates used between contact point or points will be soldered together so as to form into a complete pattern as designed.

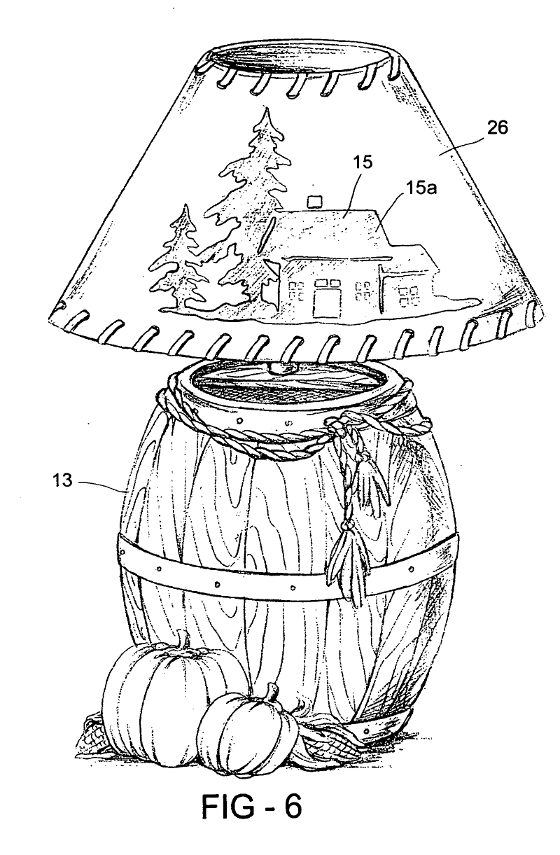

As shown in FIG. 6, the lamp shade frame 26 is made of a thin plate punched into a pattern as desired; every separate hollow pane 15a is a grouting pane 15.

The pattern designed may be a word or words, a regular pattern or an irregular pattern, or a worm, a bird, a flower or an art pattern; a lamp shade frame 26 can be formed by means of metal wires 14 or thin plates in accordance with the lamp form.

2. To make a lining form 16, the method is similar to that of making the aforesaid lamp shade frame 26; after a lining from 16 is completed, it will be mounted in the lamp shade frame 26; the lining form 16 is made of plaster, or resin, or silicon.

The lining form 16 is used as a supporting bottom surface for the acrylic liquid; the acrylic liquid will be grouted into every grouting pane 15; after the hot acrylic liquid is cooled on the lining form, every grouting pane 15 will have a figurative pane surface 25.

3. To regulate the color of the decorative panel, it can be done in accordance with the art figure and color matching required of every grouting pane 15, and in accordance with the ratio of the acrylic granules and the primary colors.

4. Grouting operation: Mount the fixture structure on the lining form 16; the grouting apparatus is under a heating condition; then, the acrylic granules are heated and melted into a liquid, which is to be grouted out of a grouting outlet under a turn-feeding method; the volume and speed of the grouting liquid is controlled with a controller so as to have the acrylic liquid flowed out slowly and steadily. After the liquid is grouted into the grouting pane 15 of the lamp shade frame 26 on the lining form 16; the liquid will be cooled gradually, and then it will be formed into a rigid decorative panel which is then stuck to the grouting pane 15.

After every grouting pane 15 is already grouted in a suitable color, the acrylic liquid will be cooled; then, remove the lining form and a decorative lamp shape 11 is completed.

Since every figurative pane surface 25 can have a decorative form and a color ornament effect, a multi-color visual effect will be shown upon the lamp is turned on as a result of the light rays going through the lamp shade.

The lamp shade 11 can be designed in different art figure; referring to photo-1, it showns a different form of lamp, of which the lamp shade 11 is made with the same method, i.e., a lamp shade with a similar stained glass.

According to the aforesaid embodiment, the features and structure of the present invention have been disclosed completely; it is apparent that the present invention has provided an evident improvement therefor, and such improvement has never been anticipated by anyone in the same field, i.e., the structure of the present invention is deemed unique.

While the invention has been described with reference to specific embodiments it must be understood that those embodiments are susceptible to many changes, substitutions, and modifications that will be readily apparent to those having ordinary skill in the art without departing from the scope and spirit of the invention.

What is claimed is:

1. A lamp shade furnished with similar stained glasses, comprising:
a lamp shade frame to be designed according to shape of a lamp, and outer edge of said lamp shade being made of upper and lower frames and a round middle frame; said round middle frame being designed according to pattern of said lamp shade, and made of a plurality of wires having different length and bent into curves respectively; a contact point between two said bent wires being soldered together; said round middle frame is substantially a decorative frame;
a decorative frame which includes lining form mounted in and under said lamp shade frame; said lamp shade frame includes a plurality of separate hollow panes, in which a melted acrylic liquid is grouted; after said melted acrylic liquid in each said hollow pane is cooled, a decorative panel is done and adhered to a grouting pane.

2. A lamp shade furnished with similar stained glasses as claimed in claim 1, wherein said decorative panel cooled on said grouting pane is made of melted acrylic liquid which is a color and transparent material.

3. A lamp shade furnished with similar stained glasses as claimed in claim 1, wherein said lamp shade frame is made of a thin metal sheet punched into a suitable and desired pattern; each of said hollow panes is a separate grouting pane.
